(19) United States
(12) Patent Application Publication
(10) Pub. No.: US 2026/0240699 A1
(43) Pub. Date: Aug. 20, 2026

(54) Tool-Free Quick-Detachable Electric Wheel Assembly

(71) Applicant: SHENG I FIRST CO., LTD., Changhua City (TW)

(72) Inventor: CHIN-TSAI TSAI, Changhua City (TW)

(21) Appl. No.: 19/549,304

(22) Filed: Feb. 25, 2026

Related U.S. Application Data
(63) Continuation-in-part of application No. 19/055,085, filed on Feb. 17, 2025.

(51) Int. Cl. A61G 5/10; A61G 5/04

(52) U.S. Cl. CPC A61G 5/1083; A61G 5/04

(57) ABSTRACT

A tool-free quick-detachable electric wheel assembly includes a drive member and a quick-detach member. The drive member has a drive shaft with a first limiting structure and a first coupling structure on a peripheral wall of one end, another end being assembled in a hub motor. The quick-detach member has a coupling body and at least one positioning member. The coupling body has a first assembly hole extending therethrough, and is sleeved on the drive shaft, at least one second limiting structure corresponding to the first limiting structure and communicating with the first assembly hole, and a second coupling structure combined with the first coupling structure to restrict rotation of the drive shaft relative to the coupling body. The at least one positioning member is assembled in the at least one second limiting structure and abuts against the first limiting structure to restrict axial displacement of the drive shaft relative to the coupling body.

### CROSS-REFERENCE TO RELATED APPLICATIONS

This application is a continuation-in-part of U.S. application Ser. No. 19/055,085, filed Feb. 17, 2025.

### FIELD OF THE INVENTION

The present disclosure relates to an electric wheel assembly, and more particularly, to a tool-free quick-detachable electric wheel assembly.

### DESCRIPTION OF THE RELATED ART

As assistive technology advances, electric wheelchairs have become an important mobility solution for users with limited mobility. To improve portability and storage, foldable wheelchair frames have been developed, and designs in which a hub motor is integrated directly into a wheelchair rim have gradually become mainstream.

However, in many existing wheel assemblies formed by a wheelchair rim and a hub motor, an assembly structure between the wheel assembly and a wheelchair frame still uses fastening members such as bolts and nuts to fasten the hub motor to the frame with a tool, thereby reducing convenience in use. Specifically, when a user wants to move an electric wheelchair into a vehicle trunk for storage, even if the frame is foldable, the user still needs to bear the weight of the entire wheelchair including hub motors. If a user (particularly an elderly user or a user with a disability) wants to detach the heavy wheel assemblies to reduce the carrying burden, the user must additionally locate a specific hand tool (such as a wrench) to detach the fastening members. Such a process is time-consuming and labor-intensive. Moreover, in outdoor or emergency situations, if a tool is not available, attachment and detachment cannot be performed, which causes a significant limitation in use.

Accordingly, developing a wheel assembly that can be quickly attached and detached without using any tool is a technical issue to be addressed.

### SUMMARY OF THE INVENTION

It is an object of the present disclosure to provide a tool-free quick-detachable electric wheel assembly, so as to solve the technical problem mentioned in the foregoing prior art.

According to an embodiment of the present disclosure, a tool-free quick-detachable electric wheel assembly includes a drive member and a quick-detach member. The drive member has a drive shaft. A peripheral wall of one end of the drive shaft is provided with a first limiting structure and a first coupling structure, and another end of the drive shaft is assembled in a hub motor. The quick-detach member has a coupling body and at least one positioning member. The coupling body has a first assembly hole extending therethrough, and the coupling body is sleeved on the drive shaft through the first assembly hole. The coupling body has at least one second limiting structure corresponding to the first limiting structure, and the at least one second limiting structure communicates with the first assembly hole. The coupling body has a second coupling structure corresponding to the first coupling structure. The second coupling structure and the first coupling structure are combined to restrict rotation of the drive shaft relative to the coupling body. The at least one positioning member is assembled in the at least one second limiting structure, and the at least one positioning member abuts against the first limiting structure of the drive shaft, so as to restrict axial displacement of the drive shaft relative to the coupling body.

In the tool-free quick-detachable electric wheel assembly, the first coupling structure has a plurality of first grooves and a plurality of first ribs, and the first grooves and the first ribs are circumferentially alternately arranged along the peripheral wall of the one end of the drive shaft. The second coupling structure has a plurality of second ribs and a plurality of second grooves, and the second ribs and the second grooves are circumferentially alternately arranged along a peripheral wall of the first assembly hole. The second ribs and the second grooves of the second coupling structure respectively correspond to and are combined with the first grooves and the first ribs of the first coupling structure.

In the tool-free quick-detachable electric wheel assembly, the at least one second limiting structure penetrates through a peripheral wall of the coupling body. The at least one positioning member is displaceably received in the at least one second limiting structure. When the at least one positioning member is displaced inwardly and protrudes beyond an inner wall of the first assembly hole, the at least one positioning member abuts against the first limiting structure.

In the tool-free quick-detachable electric wheel assembly, the quick-detach member further includes a movable member and an elastic member. The peripheral wall of the coupling body is provided with a first protrusion. The movable member is displaceably sleeved on the coupling body. A channel is formed between the movable member and the coupling body. The elastic member is received in the channel, and two ends of the elastic member respectively abut against the first protrusion and the movable member. A peripheral wall of the movable member is provided with a third protrusion. The third protrusion is configured to push the at least one positioning member, so that the at least one positioning member is displaced inwardly and abuts against the first limiting structure.

In the tool-free quick-detachable electric wheel assembly, the coupling body is provided with a first locking structure, and the movable member is provided with a second locking structure. The first locking structure has a guide section and an assembly section connected to the guide section. The second locking structure has an extension section and a mating section connected to the extension section. When the movable member is displaced, the mating section sequentially displaces axially along the guide section and rotates circumferentially along the assembly section, so as to be combined with the assembly section of the first locking structure.

In the tool-free quick-detachable electric wheel assembly, the quick-detach member further includes an assembly member. The assembly member has two first lugs disposed opposite to each other and two second lugs disposed opposite to each other. A third assembly hole is formed between the two first lugs for assembly onto a peripheral wall of the coupling body. A fourth assembly hole is formed between the two second lugs for assembly onto a frame of a wheelchair. An extension direction of the fourth assembly hole and an extension direction of the third assembly hole intersect each other in spatial projection.

In the tool-free quick-detachable electric wheel assembly, the first coupling structure includes a first recess and a first protrusion member assembled in the first recess. The first protrusion member partially protrudes beyond the first recess. The second coupling structure includes a second recess. The second recess of the second coupling structure corresponds to and is combined with the first protrusion member of the first coupling structure.

In the tool-free quick-detachable electric wheel assembly, a peripheral wall of the at least one positioning member is provided with a large-diameter portion and a small-diameter portion adjacent to each other. The at least one positioning member is displaceably slidable on the at least one second limiting structure. When the at least one positioning member is displaced such that the large-diameter portion corresponds to the first limiting structure, the large-diameter portion abuts against the first limiting structure. When the at least one positioning member is displaced such that the small-diameter portion corresponds to the first limiting structure, the large-diameter portion does not abut against the first limiting structure.

In the tool-free quick-detachable electric wheel assembly, the quick-detach member further includes an elastic member. The elastic member is sleeved on the at least one positioning member. The elastic member pushes the at least one positioning member to displace, so that the large-diameter portion is maintained in abutment against the first limiting structure.

In the tool-free quick-detachable electric wheel assembly, the quick-detach member further includes an assembly member. The assembly member has two first lugs disposed opposite to each other and two second lugs disposed opposite to each other. A third assembly hole is formed between the two first lugs for assembly onto a peripheral wall of the coupling body, and the at least one positioning member extends through the two first lugs. A fourth assembly hole is formed between the two second lugs for assembly onto a frame of a wheelchair. An extension direction of the fourth assembly hole and an extension direction of the third assembly hole intersect each other in spatial projection.

The tool-free quick-detachable electric wheel assembly provided by the present disclosure enables rapid disassembly and reassembly of the drive shaft of the drive member through the quick-detach member. For persons with limited mobility, even under conditions of limited mobility and without assistance from others, the disassembly and reassembly process may be operated by a single hand, and no tools or assistance from others is required.

The foregoing description is provided merely to illustrate the problem to be solved by the present disclosure, the technical means for solving the problem, and the resulting effects thereof. Specific details of the present disclosure will be described in the following embodiments and accompanying drawings.

### BRIEF DESCRIPTION OF DRAWINGS

FIG. 1 is a perspective view of a first embodiment of the tool-free quick-detachable electric wheel assembly of the present disclosure.

FIG. 2 is an exploded perspective view of the drive member and the quick-detach member of the first embodiment of the present disclosure.

FIG. 3 is an exploded perspective view of the quick-detach member of the first embodiment of the present disclosure.

FIG. 4 is a perspective view of the drive member and an exploded perspective view of the quick-detach member of the first embodiment of the present disclosure.

FIG. 5 is a side view of the drive member and a cross-sectional view of the quick-detach member of the first embodiment of the present disclosure.

FIG. 6 is an enlarged partial view of FIG. 5 of the first embodiment of the present disclosure.

FIG. 7 is an operational view of FIG. 6 of the first embodiment of the present disclosure.

FIG. 8 is an operational view illustrating axial displacement of the first locking structure relative to the second locking structure of the first embodiment of the present disclosure.

FIG. 9 is an operational view illustrating circumferential rotation of the first locking structure relative to the second locking structure of the first embodiment of the present disclosure.

FIG. 10 is a perspective view of a second embodiment of the tool-free quick-detachable electric wheel assembly of the present disclosure.

FIG. 11 is an exploded perspective view of the drive member and the quick-detach member of the second embodiment of the present disclosure.

FIG. 12 is an assembled perspective view of the drive member and the quick-detach member of the second embodiment of the present disclosure.

FIG. 13 is an operational view illustrating an unlocked state of the drive member and the quick-detach member of the second embodiment of the present disclosure.

FIG. 14 is an operational view illustrating a locked state of the drive member and the quick-detach member of the second embodiment of the present disclosure.

### DETAILED DESCRIPTION OF THE INVENTION

In order to provide a further understanding of the present disclosure, preferred embodiments are described below in detail with reference to the accompanying drawings.

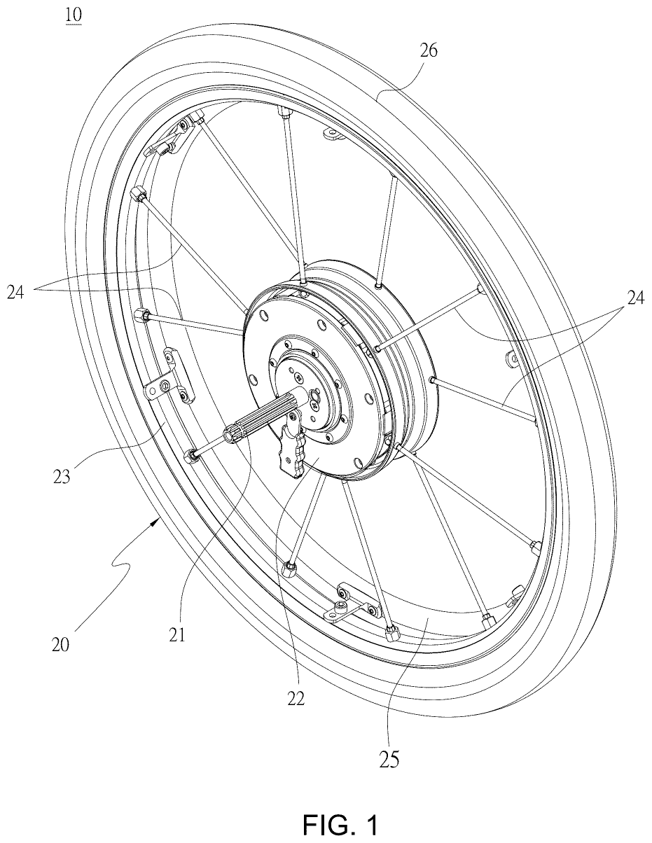

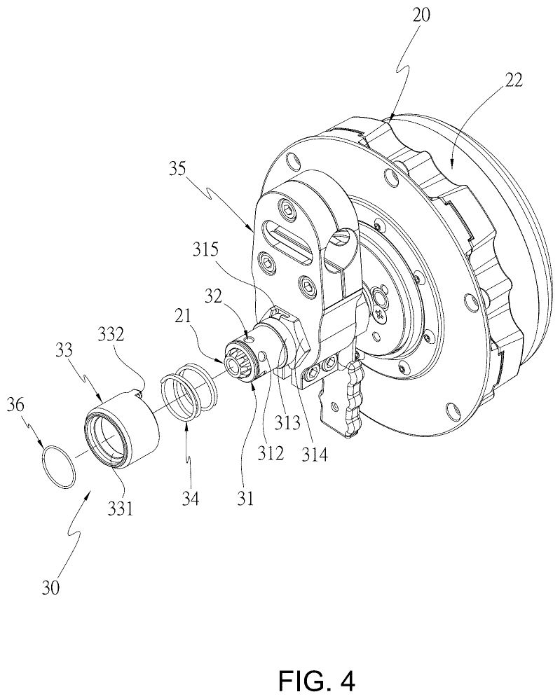

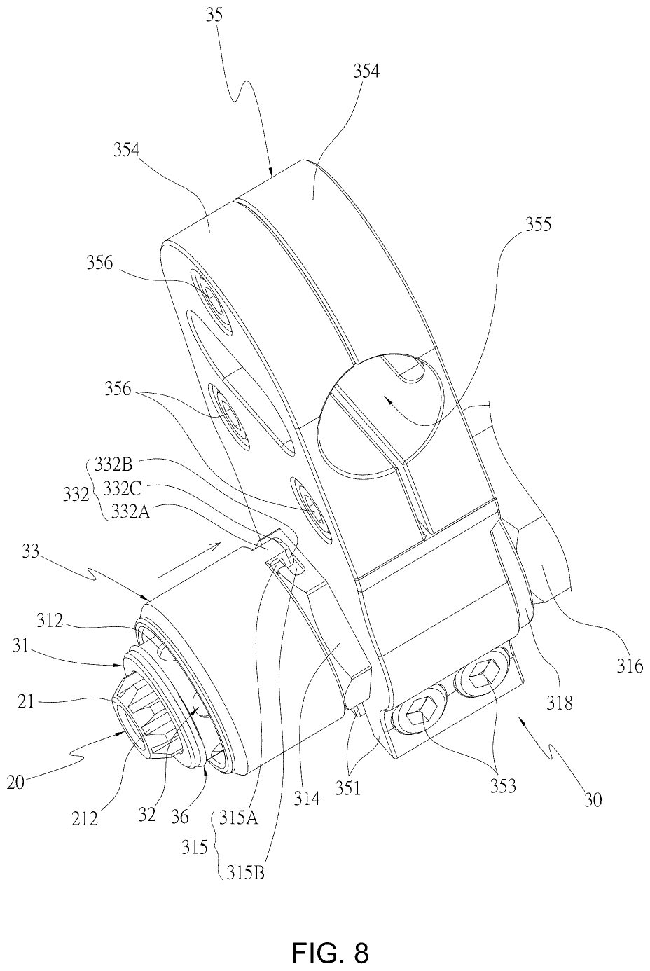

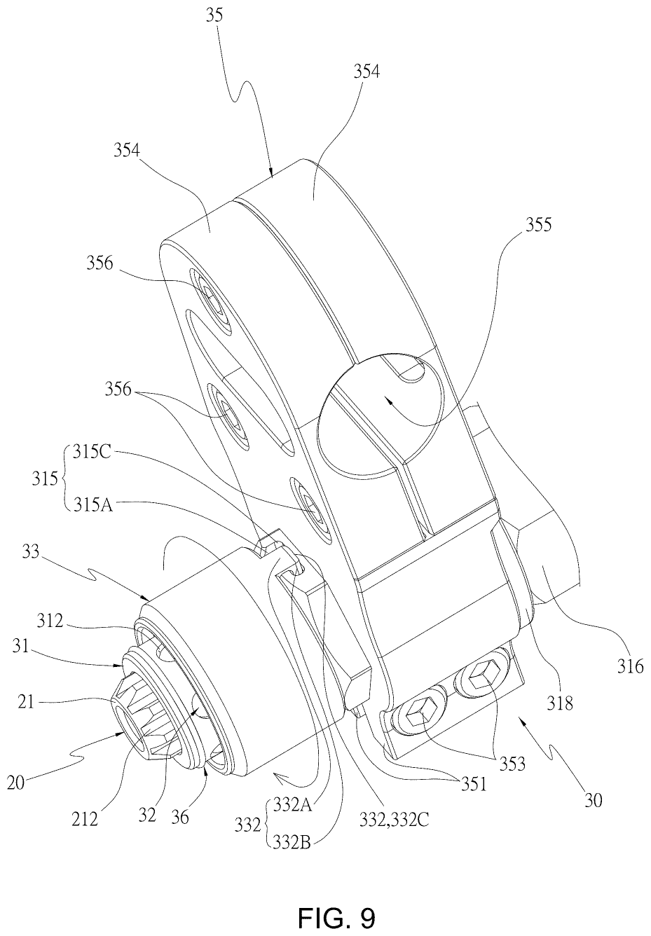

The present disclosure provides a tool-free quick-detachable electric wheel assembly. Referring simultaneously to FIGS. 1 through 9, in a first embodiment of the present disclosure, a tool-free quick-detachable electric wheel assembly 10 includes a drive member 20 and a quick-detach member 30.

Referring to FIGS. 1, 2, and 4 through 9, the drive member 20 is described as follows:

The drive member 20 has a drive shaft 21. The drive shaft 21 is substantially cylindrical. A peripheral wall of the drive shaft 21 is circumferentially provided with a first limiting structure 211. The first limiting structure 211 has an annular groove. The annular groove of the first limiting structure 211 cooperates with a corresponding element of the quick-detach member 30 to restrict axial displacement of the drive shaft 21.

In addition, the peripheral wall of the drive shaft 21 is axially provided with a first coupling structure 212. The first coupling structure 212 has a plurality of first grooves 2121 and a plurality of first ribs 2122, and the first grooves 2121 and the first ribs 2122 are circumferentially alternately arranged along the peripheral wall of the drive shaft 21. The first grooves 2121 and the first ribs 2122 of the first coupling structure 212 cooperate with a corresponding element of the quick-detach member 30 to restrict relative rotation of the drive shaft 21. In one embodiment, the annular groove of the first limiting structure 211 and the first grooves 2121 and the first ribs 2122 of the first coupling structure 212 are adjacently disposed on the peripheral wall of the drive shaft 21.

One end of the drive shaft 21 is assembled in a hub motor 22, such that another end having the first limiting structure 211 and the first coupling structure 212 is exposed. The hub motor 22 is disposed in a rim 23, and two ends of a plurality of spokes 24 are respectively assembled on a peripheral wall of the hub motor 22 and a peripheral wall of the rim 23.

The first limiting structure 211 and the first coupling structure 212 of the drive shaft 21 are disposed on one side of the rim 23. A hand rim 25 is assembled on a side wall on another side of the rim 23 to provide a user with a gripping surface for rotating the rim 23. Accordingly, with the drive shaft 21 serving as a rotational pivot, the hub motor 22, the rim 23, and the hand rim 25 rotate relative to the drive shaft 21. A tire 26 is additionally assembled on the peripheral wall of the rim 23.

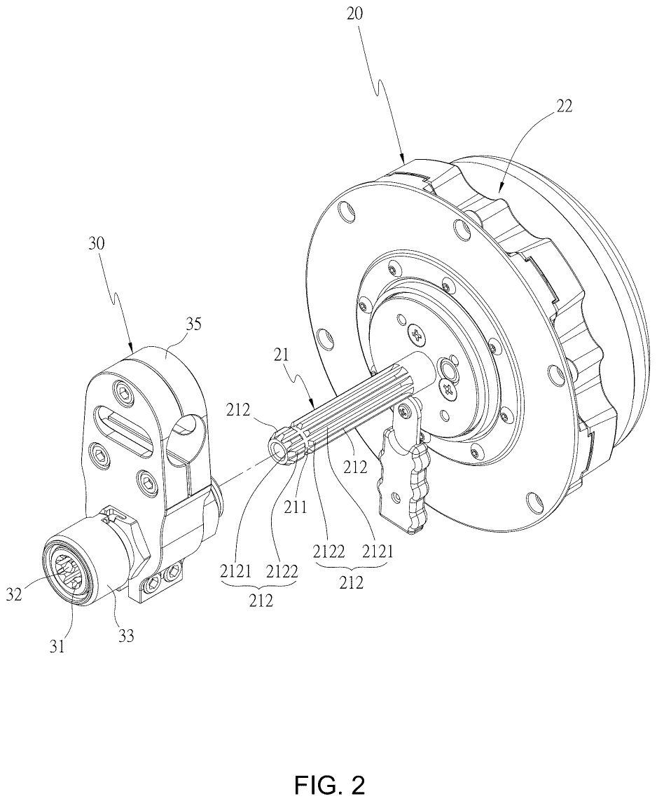

Referring to FIGS. 2 through 9, the quick-detach member 30 is described as follows:

The quick-detach member 30 has a coupling body 31, at least one positioning member 32, a movable member 33, an elastic member 34, an assembly member 35, and a blocking member 36.

The coupling body 31 of the quick-detach member 30 (as shown in FIGS. 2 through 9) is described as follows:

The coupling body 31 is substantially a hollow cylinder. A first assembly hole 311 extends axially through the coupling body 31 from one end wall to another end wall thereof. The coupling body 31 is sleeved on the drive shaft 21 of the drive member 20 through the first assembly hole 311. A peripheral wall of the first assembly hole 311 of the coupling body 31 is provided with a second coupling structure 3111 corresponding to the first coupling structure 212 of the drive shaft 21. The second coupling structure 3111 has a plurality of second ribs 31111 and a plurality of second grooves 31112, and the second ribs 31111 and the second grooves 31112 are circumferentially alternately arranged along the peripheral wall of the first assembly hole 311.

The drive shaft 21 is inserted into the first assembly hole 311 relative to the coupling body 31, such that the second coupling structure 3111 is combined with the first coupling structure 212, so that the first grooves 2121 correspond to and are combined with the second ribs 31111, and the first ribs 2122 correspond to and are combined with the second grooves 31112. In this manner, the drive shaft 21 is stably combined on the coupling body 31, and the drive shaft 21 is restricted by the coupling body 31 from relative rotation, so that the hub motor 22 rotates relative to the drive shaft 21, and the tire 26 travels in a desired direction along with rotation of the hub motor 22.

A peripheral wall at one end of the coupling body 31, corresponding to the first limiting structure 211 of the drive shaft 21, is radially provided with at least one second limiting structure 312. The second limiting structure 312 is a straight hole penetrating through the peripheral wall of the coupling body 31, such that an inner end of the straight hole of the second limiting structure 312 communicates with the first assembly hole 311. The number of the second limiting structures 312 may be six (but is not limited thereto), and the six second limiting structures 312 are annularly spaced on the peripheral wall at one end of the coupling body 31 and communicate with the first assembly hole 311.

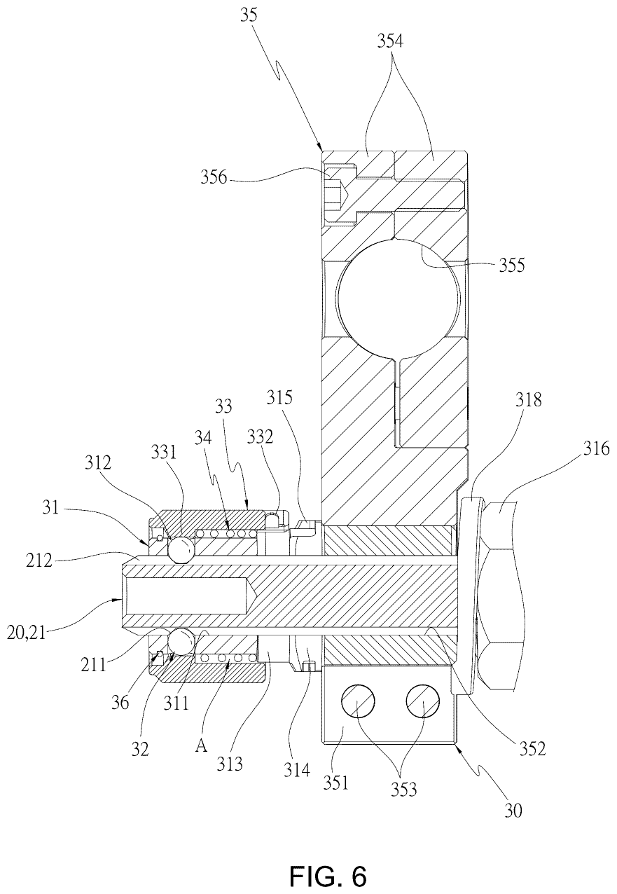

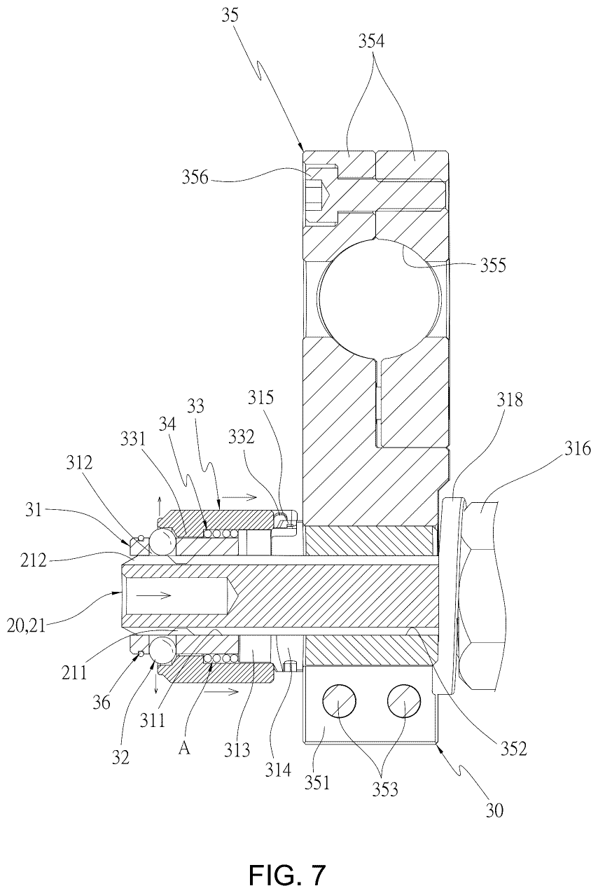

A peripheral wall of the coupling body 31 at a distance away from the second limiting structure 312 is further provided with a first protrusion 313 and a second protrusion 314 connected to the first protrusion 313, such that the adjacent first protrusion 313 and second protrusion 314 are located between two ends of the coupling body 31. In a side view of the coupling body 31, a radial height of the peripheral wall of the first protrusion 313 (as shown in FIGS. 6 and 7) is lower than a radial height of the peripheral wall of the second protrusion 314.

A peripheral wall of the second protrusion 314 adjacent to the first protrusion 313 is provided with a first locking structure 315. The first locking structure 315 is an angled groove (generally L-shaped, but is not limited thereto) as viewed in a top view of the coupling body 31. The first locking structure 315 has a guide section 315A at an end wall thereof and an assembly section 315B connected to the guide section 315A. A first angled section 315C (generally L-shaped, but is not limited thereto) is provided at a junction of the guide section 315A and the assembly section 315B.

The positioning member 32 of the quick-detach member 30 (as shown in FIGS. 2 through 9) is described as follows:

The positioning member 32 is substantially spherical. The positioning member 32 is displaceably received in the second limiting structure 312. The positioning member 32 is linearly displaced along the second limiting structure 312 upon application of force. When the positioning member 32 is displaced inwardly and protrudes beyond the inner wall of the first assembly hole 311 to abut against the first limiting structure 211 of the drive shaft 21, the drive shaft 21 is in a locked state and is unable to be axially displaced. When the positioning member 32 is displaced outwardly and does not abut against the first limiting structure 211 of the drive shaft 21, the drive shaft 21 is in an unlocked state and is able to be axially displaced. The number of the positioning members 32 may be six, and the number of the positioning members 32 corresponds to the number of the second limiting structures 312.

The movable member 33 of the quick-detach member 30 (as shown in FIGS. 2 through 9) is described as follows:

The movable member 33 is substantially annular. A peripheral wall of the movable member 33 and a peripheral wall of the coupling body 31 are formed in a mutually similar profile, such that the movable member 33 (as shown in FIGS. 6 and 7) is displaceably (displacement states include axial displacement and circumferential rotation) assembled on the coupling body 31.

A peripheral wall at one end of the movable member 33 is provided with a third protrusion 331. The third protrusion 331 may selectively abut against the positioning member 32, so that, upon application of force, the positioning member 32 is linearly displaced in the second limiting structure 312, and the positioning member 32 may selectively abut against the first limiting structure 211 of the drive shaft 21.

A peripheral wall of the movable member 33 and a peripheral wall of the coupling body 31 define a channel A (as shown in FIGS. 6 and 7). An end wall of the third protrusion 331 of the movable member 33 and a peripheral wall connected to the end wall, together with an end wall of the first protrusion 313 of the coupling body 31 and a peripheral wall connected to the end wall, define the channel A. The end wall of the third protrusion 331 may face the end wall of the first protrusion 313, and the peripheral wall connected to the end wall of the third protrusion 331 may face the peripheral wall connected to the end wall of the first protrusion 313.

Another end wall of the movable member 33 is provided with a second locking structure 332. The first locking structure 315 is disposed on the coupling body 31, the second locking structure 332 is disposed on the movable member 33, and the two are correspondingly positioned. The first locking structure 315 and the second locking structure 332 are detachably combined to form a locked state, and are detachably separated to form an unlocked state.

The second locking structure 332 is an angled protrusion (generally L-shaped, but is not limited thereto) as viewed in a side view of the movable member 33. The second locking structure 332 follows the movable member 33 to sequentially displace axially and subsequently rotate circumferentially to be combined with and locked to the first locking structure 315 of the coupling body 31. By reversing the sequence with circumferential rotation followed by axial displacement, the second locking structure 332 and the first locking structure 315 are disassembled and unlocked.

The second locking structure 332 has an extension section 332A at an end wall thereof and a mating section 332B connected to the extension section 332A. A second angled section 332C (generally L-shaped, but is not limited thereto) is provided at a junction of the extension section 332A and the mating section 332B. The mating section 332B of the second locking structure 332 of the movable member 33 follows the movable member 33 to sequentially displace axially along the guide section 315A and subsequently rotate circumferentially along the assembly section 315B to be combined with and locked to the assembly section 315B of the first locking structure 315 of the coupling body 31. By reversing the sequence with circumferential rotation followed by axial displacement, the mating section 332B and the assembly section 315B are disassembled and unlocked.

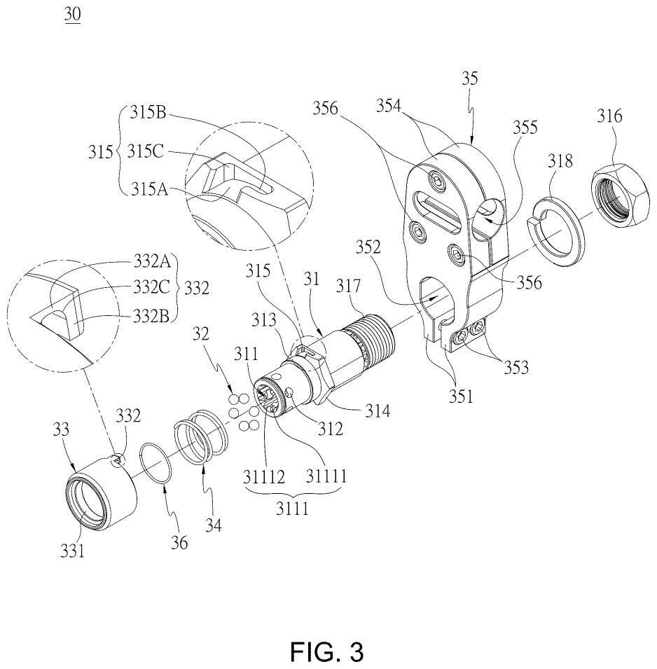

The elastic member 34 of the quick-detach member 30 (as shown in FIGS. 3 through 7) is described as follows:

The elastic member 34 may be a spring. The elastic member 34 is received in the channel A, and two ends thereof respectively abut against the third protrusion 331 and the first protrusion 313, such that the movable member 33 is elastically displaceably assembled on the coupling body 31. The movable member 33 and the coupling body 31 are relatively displaced to change a volume of the channel A and to change a deformation amount of the elastic member 34, thereby achieving elastic displacement.

The assembly member 35 of the quick-detach member 30 (as shown in FIGS. 2 through 9) is described as follows:

The assembly member 35 is a block-shaped body. One end of the assembly member 35 is symmetrically formed with two first lugs 351. A third assembly hole 352 is formed between the two first lugs 351 for assembly onto the peripheral wall of the coupling body 31. A first component 353 is fastened to end portions of the two first lugs 351, so that the two first lugs 351 and the coupling body 31 are stably joined, and so that the two first lugs 351 and the coupling body 31 are detachably separated. The number of the first components 353 may be two, but is not limited to two. When two first components 353 are employed as an embodiment, they may be fastened at spaced intervals, and the first components 353 may be screws, but are not limited to screws.

Another end of the assembly member 35 is symmetrically formed with two second lugs 354. A fourth assembly hole 355 is formed between the two second lugs 354 for assembly onto a frame of a wheelchair. A second component 356 is fastened to end portions of the two second lugs 354, so that the two second lugs 354 and the frame are stably joined, and so that the two second lugs 354 and the frame are detachably separated, and also so that the coupling body 31 is stably joined to the frame through the assembly member 35. The number of the second components 356 may be three, but is not limited to three. When three second components 356 are employed as an embodiment, they may be fastened at spaced intervals. The second components 356 may be screws, but are not limited to screws.

The fourth assembly hole 355 is located above the third assembly hole 352. In a top view of the assembly member 35, an extension direction of the fourth assembly hole 355 and an extension direction of the third assembly hole 352 intersect each other in spatial projection.

When the assembly member 35 is combined with the coupling body 31, a side wall of the assembly member 35 connected to one end opening of the third assembly hole 352 abuts against another end wall of the second protrusion 314 of the coupling body 31, and a side wall of the assembly member 35 connected to another end opening of the third assembly hole 352 abuts against one end wall of a third component 316 fastened to the coupling body 31. The third component 316 may be a nut, but is not limited to a nut. When a nut is employed as an embodiment for the third component 316, a threaded section 317 may be provided on the peripheral wall of another end of the coupling body 31 to facilitate fastening of the third component 316.

With the assembly member 35 abutting between the second protrusion 314 of the coupling body 31 and the third component 316, the assembly member 35 is prevented from unintended displacement, so that the assembly member 35 and the coupling body 31 are stably joined, and accordingly, the assembly member 35 and the frame are stably joined.

A spacer 318 is sleeved between the assembly member 35 and the third component 316 to prevent loosening, vibration, or rotation between the assembly member 35 and the third component 316. The spacer 318 may be a washer or a spring washer.

The blocking member 36 of the quick-detach member 30 (as shown in FIGS. 3 through 9) is described as follows:

The blocking member 36 is substantially a hollow annular body. The blocking member 36 is assembled on an end edge of the coupling body 31 proximate to the second limiting structure 312 to block the movable member 33, thereby preventing the movable member 33 from falling off the coupling body 31.

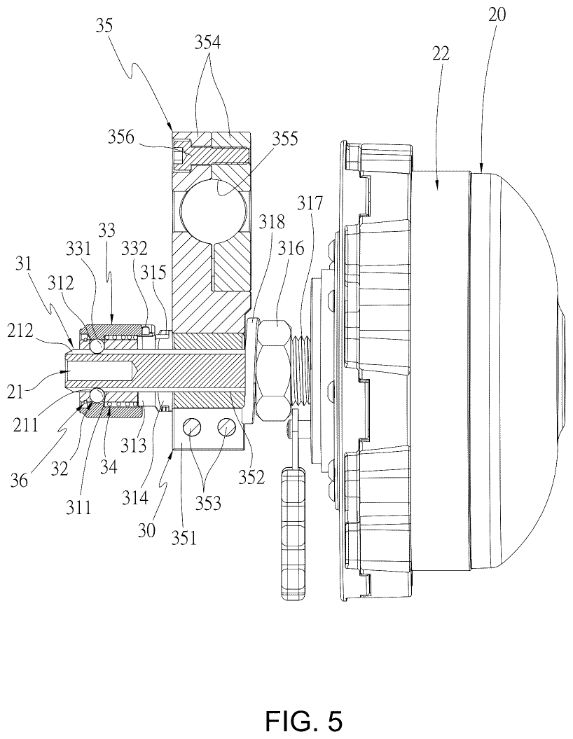

Referring to FIGS. 5 through 9, a use process of the drive member 20 and the quick-detach member 30 is described as follows:

When a user wishes to detach the drive shaft 21, or the drive shaft 21 together with its hub motor 22, the user first uses a single hand to combine the first locking structure 315 with the second locking structure 332 so as to lock them, thereby eliminating the need to continuously exert force on the movable member 33 to oppose the elastic force of the elastic member 34. As a result, the positioning member 32, without being pushed by the third protrusion 331, is able to be linearly displaced in the second limiting structure 312. At this time, the first limiting structure 211 of the drive shaft 21 is also free from abutment by the positioning member 32, and is able to move axially within the first assembly hole 311. The positioning member 32 is pushed by the axially moving drive shaft 21 and is displaced toward the peripheral wall of the coupling body 31 within the second limiting structure 312. The user is then able to use a single hand to detach the drive shaft 21, or the drive shaft 21 together with its hub motor 22, from the coupling body 31.

When a user wishes to install the drive shaft 21, or the drive shaft 21 together with its hub motor 22, the user first uses a single hand to install the drive shaft 21, or the drive shaft 21 together with its hub motor 22, onto the coupling body 31. The user then uses a single hand to disassemble the first locking structure 315 from the second locking structure 332 so as to unlock them. The movable member 33, pushed by the elastic member 34, is displaced on the coupling body 31, so that the positioning member 32 is pushed by the third protrusion 331 and displaced toward the first assembly hole 311 within the second limiting structure 312. At this time, the first limiting structure 211 of the drive shaft 21 is abutted by the positioning member 32 and is unable to move axially within the first assembly hole 311.

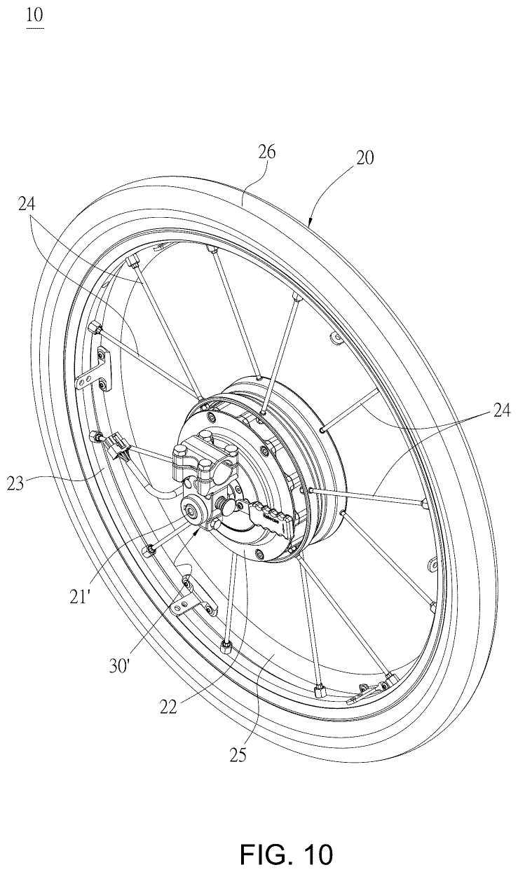

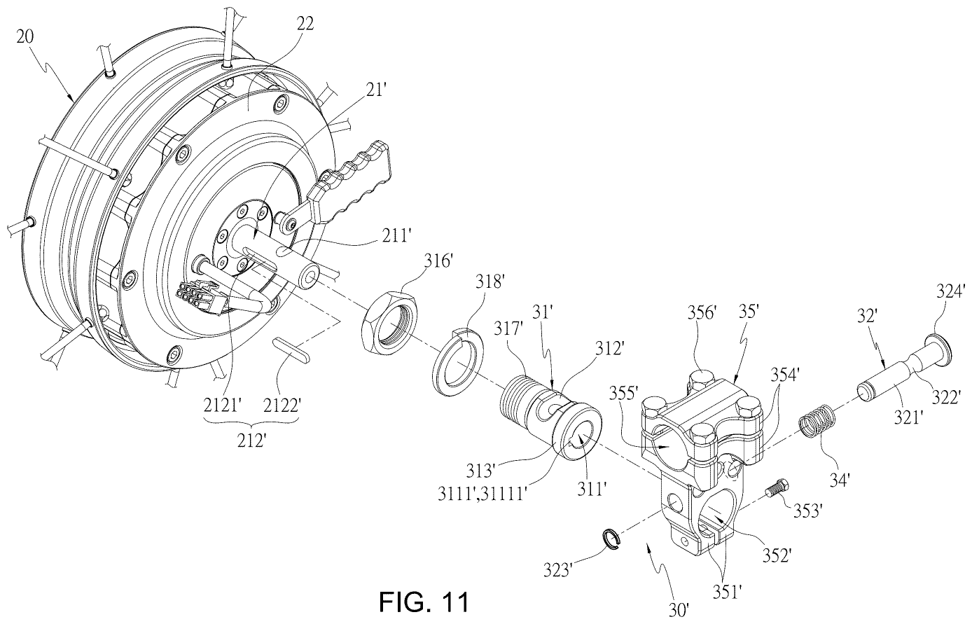

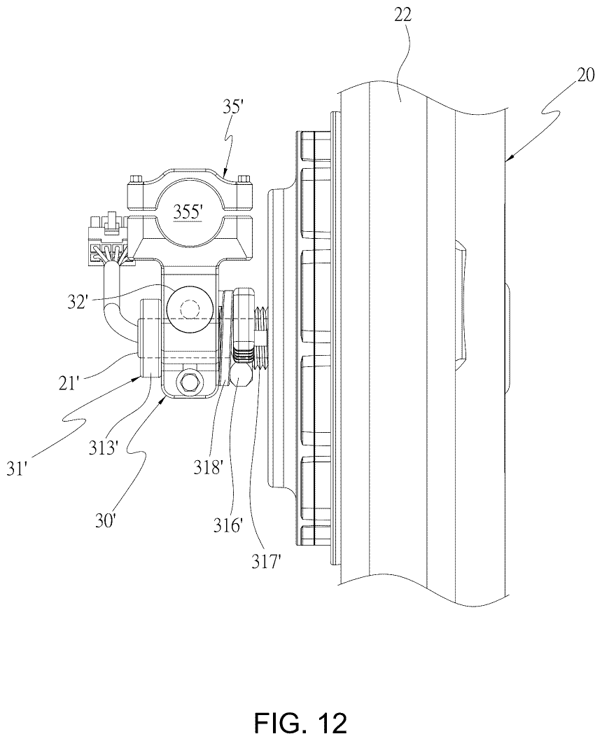

Referring simultaneously to FIGS. 10 through 14, in a second embodiment of the present disclosure, only differences from the first embodiment are described below. Among the following reference numerals, those without a prime (′) are shared between the first and second embodiments; those with a prime (′) indicate corresponding elements that differ in the second embodiment relative to the first embodiment.

The drive member 20 has a drive shaft 21′. A peripheral wall of the drive shaft 21′ is radially provided with a first limiting structure 211′. The first limiting structure 211′ has a slot. In addition, a peripheral wall of the drive shaft 21′ is axially provided with a first coupling structure 212′. The first coupling structure 212′ has a first recess 2121′, and a first protrusion member 2122′ is assembled in the first recess 2121′, such that one side of the first protrusion member 2122′ is disposed in the first recess 2121′, and an opposite side thereof is disposed outside the first recess 2121′.

The quick-detach member 30′ has a coupling body 31′, at least one positioning member 32′, an elastic member 34′, and an assembly member 35′.

The coupling body 31′ of the quick-detach member 30′ is described as follows:

The coupling body 31′ is substantially a hollow cylinder. A first assembly hole 311′ extends axially through the coupling body 31′ from one end wall to another end wall thereof. The coupling body 31′ is sleeved on the drive shaft 21′ of the drive member 20 through the first assembly hole 311′. A peripheral wall of the first assembly hole 311′ of the coupling body 31′ is provided with a second coupling structure 3111′ corresponding to the first coupling structure 212′ of the drive shaft 21′. The second coupling structure 3111′ has a second recess 31111′ corresponding to the first protrusion member 2122′ of the first coupling structure 212′.

The drive shaft 21′ is inserted into the first assembly hole 311′ relative to the coupling body 31′, such that the second recess 31111′ of the second coupling structure 3111′ is combined with the first protrusion member 2122′ of the first coupling structure 212′, so that the first protrusion member 2122′ corresponds to and is combined with the second recess 31111′. In this manner, the drive shaft 21′ is stably combined on the coupling body 31′, and the drive shaft 21′ is restricted by the coupling body 31′ from relative rotation, so that the hub motor 22 rotates relative to the drive shaft 21′, and the tire 26 travels in a desired direction along with rotation of the hub motor 22.

A peripheral wall of the coupling body 31′ between two ends thereof, corresponding to the first limiting structure 211′ of the drive shaft 21′, is radially provided with at least one second limiting structure 312′. The second limiting structure 312′ is a slot, such that a slot bottom of the second limiting structure 312′ communicates with the first assembly hole 311′. The number of the second limiting structures 312′ may be one (but is not limited thereto), and one second limiting structure 312′ is disposed on the peripheral wall between two ends of the coupling body 31′ and communicates with the first assembly hole 311′. A peripheral wall at one end of the coupling body 31′ is further provided with a first protrusion 313′.

The positioning member 32′ of the quick-detach member 30′ is described as follows:

The positioning member 32′ is substantially cylindrical. The positioning member 32′ is displaceably slidable on the second limiting structure 312′. The positioning member 32′ is linearly displaced along the second limiting structure 312′ upon application of force. When the positioning member 32′ abuts against the first limiting structure 211′ of the drive shaft 21′, the drive shaft 21′ is in a locked state and is unable to be axially displaced. When the positioning member 32′ does not abut against the first limiting structure 211′ of the drive shaft 21′, the drive shaft 21′ is in an unlocked state and is able to be axially displaced. The number of the positioning members 32′ may be one, and the number of the positioning members 32′ corresponds to the number of the second limiting structures 312′.

A peripheral wall between two ends of the positioning member 32′ is provided with a large-diameter portion 321′ and a small-diameter portion 322′ adjacent to each other. When the positioning member 32′ is linearly displaced such that the large-diameter portion 321′ abuts against the first limiting structure 211′ of the drive shaft 21′, the drive shaft 21′ is in a locked state and is unable to be axially displaced. When the positioning member 32′ is linearly displaced such that the small-diameter portion 322′ corresponds to the first limiting structure 211′, and the large-diameter portion 321′ does not abut against the first limiting structure 211′, the drive shaft 21′ is in an unlocked state and is able to be axially displaced.

Two ends of the positioning member 32′ are respectively provided with a first stop portion 323′ and a second stop portion 324′, so as to limit a linear displacement stroke of the positioning member 32′.

The elastic member 34′ of the quick-detach member 30′ is described as follows:

The elastic member 34′ may be a spring. The elastic member 34′ is sleeved on the positioning member 32′, such that the positioning member 32′ is elastically displaceable.

The assembly member 35′ of the quick-detach member 30′ is described as follows:

The assembly member 35′ is a block-shaped body. One end of the assembly member 35′ is symmetrically formed with two first lugs 351′. A third assembly hole 352′ is formed between the two first lugs 351′ for assembly onto the peripheral wall of the coupling body 31′ and corresponding to the second limiting structure 312′. A first component 353′ is fastened to end portions of the two first lugs 351′, so that the two first lugs 351′ and the coupling body 31′ are stably joined, and so that the two first lugs 351′ and the coupling body 31′ are detachably separated. The number of the first components 353′ may be one, but is not limited to one, and the first components 353′ may be screws, but are not limited to screws.

The positioning member 32′ extends through the two first lugs 351′. The first stop portion 323′ and the second stop portion 324′ are respectively located on outer sides of the two first lugs 351′ and respectively abut against the two first lugs 351′, so as to limit the linear displacement stroke of the positioning member 32′. Two ends of the elastic member 34′ respectively abut against the assembly member 35′ and the positioning member 32′.

Another end of the assembly member 35′ is symmetrically formed with two second lugs 354′. A fourth assembly hole 355′ is formed between the two second lugs 354′ for assembly onto a frame of a wheelchair. A second component 356′ is fastened to end portions of the two second lugs 354′, so that the two second lugs 354′ and the frame are stably joined, and so that the two second lugs 354′ and the frame are detachably separated, and also so that the coupling body 31′ is stably joined to the frame through the assembly member 35′. The number of the second components 356′ may be four, but is not limited to four. When four second components 356′ are employed as an embodiment, they may be fastened at spaced intervals. The second components 356′ may be screws, but are not limited to screws.

The fourth assembly hole 355′ is located above the third assembly hole 352′. In a top view of the assembly member 35′, an extension direction of the fourth assembly hole 355′ and an extension direction of the third assembly hole 352′ intersect each other in spatial projection.

When the assembly member 35′ is combined with the coupling body 31′, a side wall of the assembly member 35′ connected to one end opening of the third assembly hole 352′ abuts against an end wall of the first protrusion 313′ of the coupling body 31′, and a side wall of the assembly member 35′ connected to another end opening of the third assembly hole 352′ abuts against one end wall of a third component 316′ of the coupling body 31′. The third component 316′ may be a nut, but is not limited to a nut. When a nut is employed as an embodiment for the third component 316′, a threaded section 317′ may be provided on the peripheral wall of another end of the coupling body 31′ to facilitate fastening of the third component 316′.

With the assembly member 35′ abutting between the first protrusion 313′ of the coupling body 31′ and the third component 316′, the assembly member 35′ is prevented from unintended displacement, so that the assembly member 35′ and the coupling body 31′ are stably joined, and accordingly, the assembly member 35′ and the frame are stably joined.

A spacer 318′ is sleeved between the assembly member 35′ and the third component 316′ to prevent loosening, vibration, or rotation between the assembly member 35′ and the third component 316′. The spacer 318′ may be a washer or a spring washer.

A use process of the drive member 20 and the quick-detach member 30′ is described as follows:

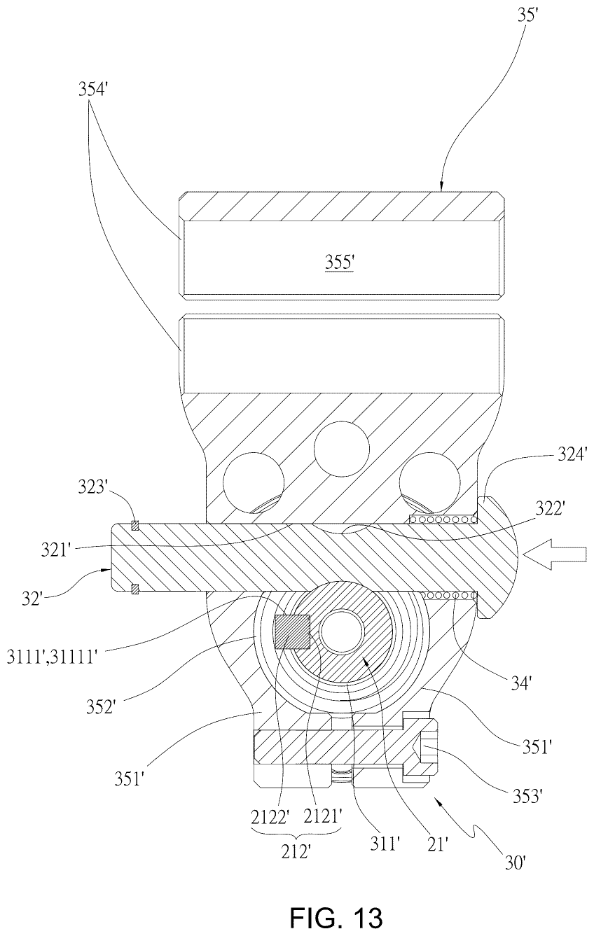

Referring to FIG. 13, when a user pushes the positioning member 32′ with a single hand, and the small-diameter portion 322′ corresponds to the first limiting structure 211′, the large-diameter portion 321′ does not abut against the first limiting structure 211′. The drive shaft 21′ is in an unlocked state and is able to be axially displaced. The user is then able to use a single hand to detach the drive shaft 21′ from the coupling body 31′ of the quick-detach member 30′.

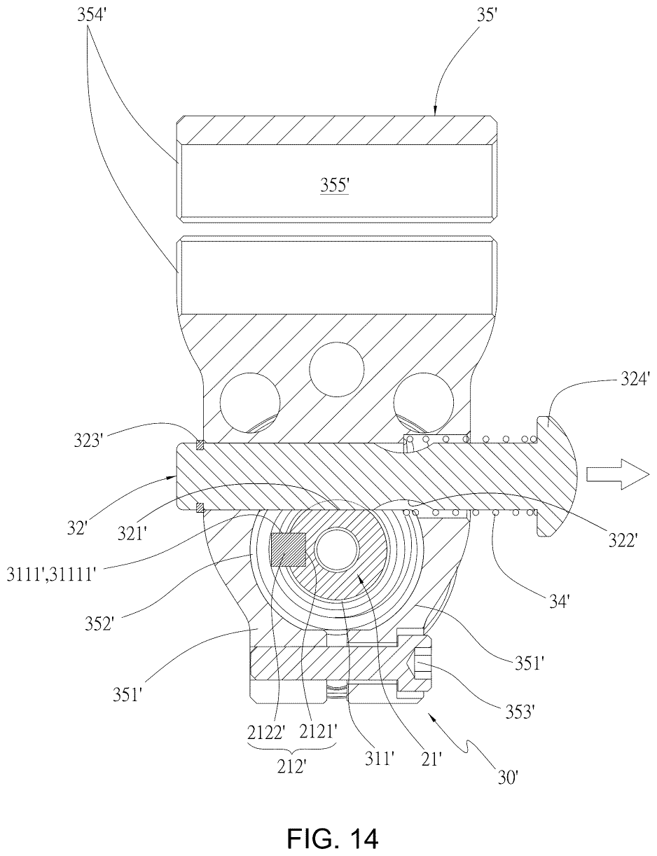

Referring to FIG. 14, when the user does not push the positioning member 32′, the positioning member 32′ is pushed by the elastic member 34′ and returns to an initial position, such that the positioning member 32′ is linearly displaced until the large-diameter portion 321′ abuts against the first limiting structure 211′ of the drive shaft 21′. The drive shaft 21′ is in a locked state and is unable to be axially displaced. The drive shaft 21′ is maintained in an assembled state on the coupling body 31′ of the quick-detach member 30′.

The terms “first,” “second,” “third,” and “fourth” as used in the present disclosure are for distinction purposes and do not represent a sequential order.

In summary, the tool-free quick-detachable electric wheel assembly 10 provided by the present disclosure enables rapid disassembly and reassembly of the drive shaft 21, 21′ of the drive member 20 through the quick-detach member 30, 30′. For persons with limited mobility, even under conditions of limited mobility and without assistance from others, the disassembly and reassembly process may be operated by a single hand, and no tools or assistance from others is required.

Finally, the embodiments disclosed above are not intended to limit the present disclosure. Any person skilled in the art may make various modifications and refinements without departing from the spirit and scope of the present disclosure, all of which are protected within the scope of the present disclosure. Therefore, the scope of protection of the present disclosure shall be defined by the appended claims.

What is claimed is

1. A tool-free quick-detachable electric wheel assembly, comprising:
a drive member, the drive member having a drive shaft, a peripheral wall of one end of the drive shaft being provided with a first limiting structure and a first coupling structure, another end of the drive shaft being assembled in a hub motor; and
a quick-detach member, the quick-detach member having a coupling body and at least one positioning member, the coupling body having a first assembly hole extending therethrough, the coupling body being sleeved on the drive shaft through the first assembly hole, the coupling body having at least one second limiting structure corresponding to the first limiting structure, the at least one second limiting structure communicating with the first assembly hole, the coupling body having a second coupling structure corresponding to the first coupling structure, the second coupling structure and the first coupling structure being combined to restrict rotation of the drive shaft relative to the coupling body, the at least one positioning member being assembled in the at least one second limiting structure, the at least one positioning member abutting against the first limiting structure of the drive shaft, so as to restrict axial displacement of the drive shaft relative to the coupling body.

2. The tool-free quick-detachable electric wheel assembly according to claim 1, wherein the first coupling structure has a plurality of first grooves and a plurality of first ribs, and the first grooves and the first ribs are circumferentially alternately arranged along the peripheral wall of the one end of the drive shaft, the second coupling structure has a plurality of second ribs and a plurality of second grooves, and the second ribs and the second grooves are circumferentially alternately arranged along a peripheral wall of the first assembly hole, and the second ribs and the second grooves of the second coupling structure respectively correspond to and are combined with the first grooves and the first ribs of the first coupling structure.

3. The tool-free quick-detachable electric wheel assembly according to claim 2, wherein the at least one second limiting structure penetrates through a peripheral wall of the coupling body, the at least one positioning member is displaceably received in the at least one second limiting structure, and when the at least one positioning member is displaced inwardly and protrudes beyond an inner wall of the first assembly hole, the at least one positioning member abuts against the first limiting structure.

4. The tool-free quick-detachable electric wheel assembly according to claim 3, wherein the quick-detach member further comprises a movable member and an elastic member, the peripheral wall of the coupling body is provided with a first protrusion, the movable member is displaceably sleeved on the coupling body, a channel is formed between the movable member and the coupling body, the elastic member is received in the channel, and two ends of the elastic member respectively abut against the first protrusion and the movable member, a peripheral wall of the movable member is provided with a third protrusion, and the third protrusion is configured to push the at least one positioning member, so that the at least one positioning member is displaced inwardly and abuts against the first limiting structure.

5. The tool-free quick-detachable electric wheel assembly according to claim 4, wherein the coupling body is provided with a first locking structure, the movable member is provided with a second locking structure, the first locking structure has a guide section and an assembly section connected to the guide section, the second locking structure has an extension section and a mating section connected to the extension section, and when the movable member is displaced, the mating section sequentially displaces axially along the guide section and rotates circumferentially along the assembly section, so as to be combined with the assembly section of the first locking structure.

6. The tool-free quick-detachable electric wheel assembly according to claim 1, wherein the quick-detach member further comprises an assembly member, the assembly member has two first lugs disposed opposite to each other and two second lugs disposed opposite to each other, a third assembly hole is formed between the two first lugs for assembly onto a peripheral wall of the coupling body, a fourth assembly hole is formed between the two second lugs for assembly onto a frame of a wheelchair, and an extension direction of the fourth assembly hole and an extension direction of the third assembly hole intersect each other in spatial projection.

7. The tool-free quick-detachable electric wheel assembly according to claim 1, wherein the first coupling structure comprises a first recess and a first protrusion member assembled in the first recess, the first protrusion member partially protrudes beyond the first recess, the second coupling structure comprises a second recess, and the second recess of the second coupling structure corresponds to and is combined with the first protrusion member of the first coupling structure.

8. The tool-free quick-detachable electric wheel assembly according to claim 7, wherein a peripheral wall of the at least one positioning member is provided with a large-diameter portion and a small-diameter portion adjacent to each other, the at least one positioning member is displaceably slidable on the at least one second limiting structure, when the at least one positioning member is displaced such that the large-diameter portion corresponds to the first limiting structure, the large-diameter portion abuts against the first limiting structure, and when the at least one positioning member is displaced such that the small-diameter portion corresponds to the first limiting structure, the large-diameter portion does not abut against the first limiting structure.

9. The tool-free quick-detachable electric wheel assembly according to claim 8, wherein the quick-detach member further comprises an elastic member, the elastic member is sleeved on the at least one positioning member, and the elastic member pushes the at least one positioning member to displace, so that the large-diameter portion is maintained in abutment against the first limiting structure.

10. The tool-free quick-detachable electric wheel assembly according to claim 7, wherein the quick-detach member further comprises an assembly member, the assembly member has two first lugs disposed opposite to each other and two second lugs disposed opposite to each other, a third assembly hole is formed between the two first lugs for assembly onto a peripheral wall of the coupling body, and the at least one positioning member extends through the two first lugs, a fourth assembly hole is formed between the two second lugs for assembly onto a frame of a wheelchair, and an extension direction of the fourth assembly hole and an extension direction of the third assembly hole intersect each other in spatial projection.
